(19) United States
(12) Patent Application Publication
(10) Pub. No.: US 2025/0058654 A1
(43) Pub. Date: Feb. 20, 2025

(54) Battery Container, System And Vehicle

(71) Applicant: HOPPECKE Systemtechnik GmbH, Zwickau (DE)

(72) Inventors: Stefan REINHOLD, Zwickau (DE); Magnus TRAPP, Bad Wünnenberg (DE); Chris Peter RUMMEL, Brilon (DE)

(21) Appl. No.: 18/806,035

(22) Filed: Aug. 15, 2024

(30) Foreign Application Priority Data
Aug. 16, 2023 (EP) 23191720.4

(51) Int. Cl. B60L 50/64; B61C 3/00

(52) U.S. Cl. CPC B60L 50/64; B61C 3/00

(57) ABSTRACT

A battery container for rail vehicles, in particular railways and tramways, comprises a casing that provides an inner space for housing lithium-ion batteries. The casing includes a safety fitting that is designed to divert at least one fluid from the inner space of the casing in case of exceeding a presettable actuation pressure and to fluid-tightly seal the casing on falling below a presettable closing pressure.

### CROSS-REFERENCE TO RELATED APPLICATIONS

The present disclosure claims the benefit of European Application No. 23191720.4, filed on Aug. 16, 2023. The entire disclosure of the application referenced above is incorporated herein by reference.

### FIELD

This disclosure relates to a battery container for rail vehicles, in particular railways and tramways, comprising a casing that provides an inner space for housing lithium-ion batteries. Moreover, the disclosure relates to a system comprising a battery container and a lithium-ion battery as well as a vehicle, in particular a rail vehicle, preferably a railway or a tramway, with a system according to the disclosure.

### BACKGROUND

Battery containers for lithium-ion batteries are known on the merits from the prior art. However, if a use is envisaged for vehicles, in particular for rail vehicles, the storage of lithium-ion batteries must meet specific safety standards.

In particular, the battery container has to be constructed on the one hand fluid-tight and fireproof on the other hand.

However, it has become apparent that common battery containers—not specifically designed for lithium-ion batteries—burst in case of thermal runaway of the lithium-ion batteries that are located in the inner space and thus not only do not meet the required standards, but also mean a significant safety risk. The reason is that, in case of thermal runaway of lithium-ion batteries, it comes to sudden deflagrations and to the development of fire gases so that the inner pressure instantaneously increases which inevitably leads to the bursting thereof.

It is known to provide battery containers with rupture discs that are made of thin metal foils and that irreversibly tear upon exceeding a certain inner pressure and thus enable a pressure balance with the environment. However, these known rupture discs do not meet the fire protection properties required in the rail sector for operating lithium-ion batteries. Furthermore, once the overpressure is released, the penetration of fresh air into the inside of the container is thus made possible which can result to an intensification of a possible battery fire.

Moreover, a liquid impermeable but gas permeable membrane is known from EP 1 947 712 B1, wherein this membrane makes possible a continuous pressure balance between a battery casing and a gas conducting system for the discharge of in particular hydrogen gas. However, such a membrane cannot evacuate the sudden inner pressure building up in case of thermal runaway of a lithium-ion battery since the volume flow through the membrane is too low. The membrane would rather be destroyed due to the pressure load thereon.

Therefore, the aim of the disclosure is to indicate a battery container that remains fully functional even in case of a thermal runaway of the batteries arranged therein and that prevents or restrains a possible fire of the batteries.

### SUMMARY

For achieving this aim, the disclosure proposes a battery container for rail vehicles, in particular railways and tramways, comprising a casing that provides an inner space for housing lithium-ion batteries, characterized in that the casing comprises a safety fitting that is designed to divert at least one fluid from the inner space of the casing in case of exceeding a presettable response pressure and to fluid-tightly seal the casing on falling below a presettable closing pressure.

With the disclosure, gas developing in the inside, in particular caused by a fire or a deflagration, can immediately, preferably automatically, be discharged upon reaching a critical response pressure, and a pressure balance with the environment can thus be produced. Should then the pressure fall below a presettable closure pressure after the gas has been discharged, the safety fitting closes again, preferably automatically. The casing is thus again fluid-tightly sealed. Unlike to a rupture disc known from the prior art, the entry of oxygen or the escape of toxic battery fluids is thus also excluded after achieving, the pressure balance. The risk for damaging the health of persons located in the surrounding area of the battery container is therewith considerably reduced. The risk of consequential damage for the battery container itself as well as for the vehicle housing the battery container also significantly decreases.

A “safety fitting” in the sense of the disclosure refers to a unit that protects potentially pressurized rooms or pressure vessels, in this case the casing of the battery container, against an inadmissible pressure increase in the inner space. An “inadmissible pressure increase” is, in the sense of the disclosure, an increase for which there is a risk that the casing sustains irreversible damage and it runs the risk to burst. To differentiate between an admissible and an inadmissible pressure increase, a response pressure of the safety fitting in the sense of a specific pressure value or of a corresponding range of values can be preset. This being, the safety fitting can be controlled in such a manner that, when exceeding the response pressure, gas, vapors or liquids are released into the atmosphere or into a collection system such as, for example into collecting pipes or into a collecting tank. This being, the response pressure is the pressure for which the safety fitting starts to open for blowing off the pressure. The safety fitting preferably has a response pressure of 50 hPa to 100 hPa, preferably of 65 hPa to 85 hPa, in particular of 75 hPa. The response pressure preferably is subject to a tolerance of ±3%. By contrast, the closure pressure is the pressure value for which the safety fitting is completely closed again after the overpressure has been blown off. This value is preferably 10% to 20% below the response pressure. A further parameter of the safety fitting according to the disclosure is the “opening pressure”. This is the value for which the safety fitting reaches the maximal degree of opening for the necessary mass flow to be discharged. The opening pressure can be preset just like the response pressure. The opening pressure can preferably correspond to the response pressure or be preferably 5% to 10% above the response pressure.

A preferred characteristic of the disclosure provides that the safety fitting is designed as a check valve. A check valve is a component that enables the flow of a fluid (liquid, gas) in only one direction. To this end, the check valves preferably comprise a closing element that is in particular spring loaded. The closing element closes in one direction, in particular due to the spring, whereas in the other direction it is released by the pressure of the flowing fluid. This being, the closing element is pushed into a gasket seat of the fitting. If there is a pressure in the forward direction that can overcome the restoring force, in particular that of the spring, the closing element is lifted by the gasket seat and the flow is free.

Generally, the safety fitting preferably comprises a static part and a movable part. Insofar, the safety fitting is designed in at least two parts. This being, the static part of the safety fitting is arranged on the casing immovably relative thereto. By contrast, the movable part is arranged movable to the casing on the static part of the safety fitting. The movable part provides the closing element. The static part provides a gasket seat with a sealing means. This being, a passage hole configured in the casing outer wall is enclosed by the gasket seat. The movable part sits below the presettable response pressure in the static part and closes the passage hole fluid-tightly, in particular gas-tightly. Once the presettable response pressure is reached, the movable part is pushed by the inner pressure in the casing out of the static part so that the passage hole is unsealed and a fluid flow from the inside of the casing to the outer side of the casing is enabled. When the closure pressure is subsequently undershot, the movable part strikes back preferably instantly into the static part and closes the passage opening again fluid-tightly, in particular gas-tightly.

Depending on the design of the safety fitting, in particular of the check valve, it is provided that the movable part of the safety fitting is rotationally and/or translationally hinged on the static part. It is thus possible that, upon reaching the response pressure, the movable part of the safety fitting can be deflected and/or displaced by a rotational and/or translational movement out of the closed position and thus serve to generate a flow communication between the inside of the casing and the outer side of the casing for the purpose of pressure balance. Preferably, the deflection and/or displacement of the movable part causes the building up of a restoring force of a spring directed against the deflection and/or displacement direction. On falling below the closing pressure, the restoring force of the spring applied to the movable part causes that the movable part is moved back from the opened position to the closed position.

According to a preferred characteristic of the disclosure, it is provided that the check valve is designed as a non-return flap. Therefore, the movable part of the non-return flap is articulated via one of its edges on the static part of the non-return flap or on the casing. The design of the non-return flap has the advantage of a comparatively simple constructive design.

According to a preferred characteristic of the disclosure, it is provided that the check valve is designed as a non-return valve, in particular as a plate check valve. Therefore, the movable part of the non-return valve is designed linearly movable in the axial direction with respect to the static part of the non-return valve or of the casing. To this end, the movable part of the non-return valve comprises a guide portion that is linearly movably guided in a guide seat of the static part of the non-return valve or of the casing. Furthermore, the movable part of the valve comprises a closing element that can be designed in particular as a ball or a plate. The closing element is preferably designed as a plate. The non-return valve is thus designed as a plate check valve. The design as a non-return valve has also proved to be mechanically comparatively stable for a wide range of opening/closing processes. Furthermore, a valve enables extended possibilities for the control and/or regulation.

The non-return valve is preferably designed as a proportional valve or a full stroke check valve. The differences as well as the advantages and disadvantages of both valve types lie in the opening behavior. The opening behavior of a proportional valve between reaching the response pressure and complete opening is proportional to the pressure. For proportional valves, the opening pressure is preferably above the response pressure. By contrast, the full stroke check valve opens suddenly upon reaching the response pressure and with full stroke. For full stroke valves, the opening pressure preferably corresponds to the response pressure. Proportional valves are advantageously more versatile since they enable a control of the volume flow. Conversely, full stroke check valves provide a higher level of safety, in particular with respect to sudden pressure increases in the inner space, for instance due to spontaneous deflagration, since the entire flow cross section is instantaneously available.

According to a preferred characteristic of the disclosure, it is provided that the safety fitting is designed to automatically open a flow communication between the inner space of the casing and the outer side of the casing, once the presettable response pressure in the inner space of the casing is reached, and to automatically shut-off the flow communication on falling below the presettable closing pressure in the inner space of the casing. This being, the safety fitting is preferably spring-loaded against the pressure acting thereon in the inner space of the casing.

The disclosure is characterized by at least one spring that bears at one end on the inner side of the casing or on the static part of the safety fitting and, at the other end, on the movable part of the safety fitting. The spring is preferably designed as a torsion spring when the safety fitting is designed as a non-return flap. Conversely, it is preferred that the spring is designed as a helical tension spring or as a helical compression spring when the safety fitting is designed as a non-return valve.

According to a preferred characteristic of the disclosure, it is provided that the safety fitting is at least partly made of metal or is coated therewith. In particular, it is made or coated with a corrosion resistant metal with respect to the electrolyte of a li-ion-battery. The metal can in particular be titanium or a titanium containing alloy.

According to a preferred characteristic of the disclosure, a collecting pipe and/or a collecting tank is provided that is fluidically connected with the inner space of the casing, when exceeding the presettable response pressure. This ensures that fluids and/or gas detrimental to health and/or environmentally harmful are not directly discharged into a passenger compartment or into the atmosphere. Such fluids can rather be conveyed to a safe exit location by means of the collecting pipe, or collected and temporarily stored in the collecting tank. The collecting tank and the collecting pipe can insofar be combined with one another so that fluids discharged from the inner space of the casing by means of the collecting pipe can be conveyed by means of the collecting type to a collecting tank arranged at a safe place. The combination of several collecting pipes and of a collecting tank is also conceivable.

Moreover, the disclosure relates to a system with a battery container according to the disclosure, wherein at least one lithium-ion-battery is arranged in the inner space of the battery container.

A ‘lithium-ion battery” in the sense of this disclosure always comprises its own battery casing for receiving electrodes, separator(s) and/or electrolyte. The battery casing on its part is preferably fluid-tightly closed. This being, it can have its own overpressure mechanism. The battery container according to the disclosure serves to accommodate a multitude of lithium-ion batteries that in turn each has an own battery casing. The multitude of lithium-ion batteries is preferably connected with one another by a tube technology to a battery unit.

Moreover, the disclosure relates to a railway or a tramway with a system according to the disclosure.

### BRIEF DESCRIPTION OF DRAWINGS

The disclosure is explained below by means of examples.

FIG. 1 shows a perspective view of the inner space of the casing of a safety fitting according to the disclosure according to a first embodiment, seen in closed position.

FIG. 2 shows a perspective view of the inner space of the casing of a safety fitting according to the disclosure according to FIG. 1, seen in opened position.

FIG. 3 shows a side view of a safety fitting according to FIG. 1, in closed position.

FIG. 4 shows a side view of a safety fitting according to FIG. 1, in opened position.

FIG. 5 shows a perspective view of the inner space of the casing of a safety fitting according to the disclosure according to a second embodiment, seen in closed position.

FIG. 6 shows a perspective view of the inner space of the casing of a safety fitting according to the disclosure according to FIG. 5, seen in opened position.

FIG. 7 shows a side view of a safety fitting according to FIG. 5, in closed position.

FIG. 8 shows a side view of a safety fitting according to FIG. 5, in opened position.

### DETAILED DESCRIPTION

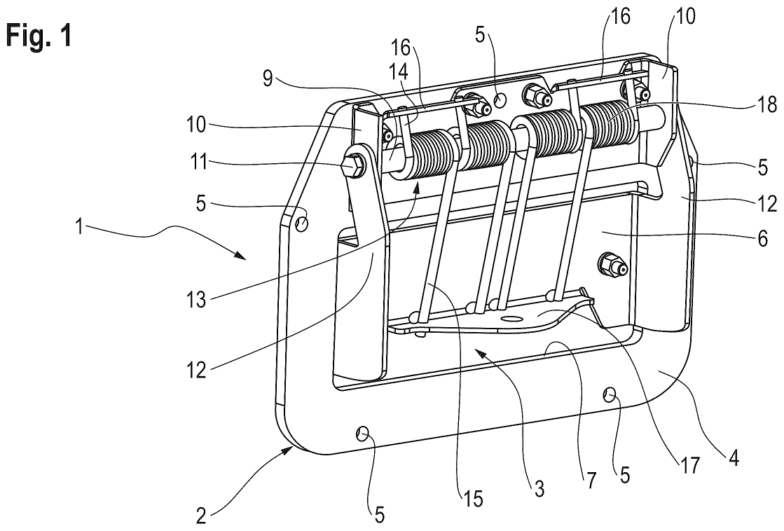

FIG. 1 shows a first safety fitting 1 according to the disclosure. The safety fitting 1 is here designed as a non-return flap. The design of the non-return flap has the advantage of a comparatively simple constructive design.

It comprises a static part 2 and a movable part 3. Insofar, the safety fitting 1 is designed in at least two parts. This being, the static part 2 of the safety fitting 1 is arranged on the casing, that is not represented here, immovably relative thereto. For the immovable arrangement on the casing, the static part 2 that comprises here a circumferential frame 4 has holes for receiving fixing means such as screws for example. The holes 5 are provided by the frame 4.

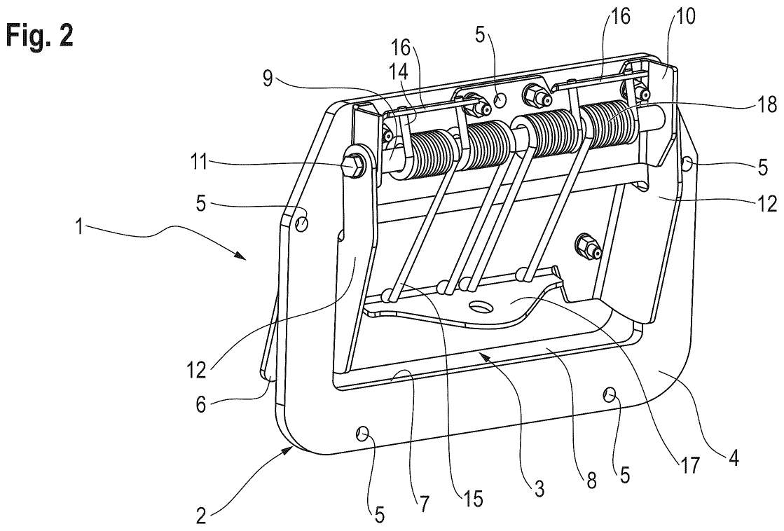

By contrast, the movable part 3 is arranged movable relative to the housing and to the static part 2 on the static part 2 of the safety fitting 1. The movable part 3 provides a closing element as a flap. The static part 2 provides a gasket seat 7 with a not shown sealing means. This being, a passage hole 8 (FIG. 2) is enclosed by the gasket seat 7. The movable part 3 sits6 below the presettable response pressure in the static part and closes the passage hole fluid-tightly, in particular gas-tightly.

The movable part 3 of the safety fitting is here rotationally hinged on the static part 2. To this end, the static part 2 provides a shaft 9. The shaft 9 is positioned rotationally movable in two shaft mounts 10 arranged opposite to one another on the frame 4. The shaft 9 is connected by screws 11 with respectively a rotating arm 12 of the movable part 3. It is thus possible that, when reaching the response pressure, the movable part 3 of the fitting 1 can be deflected from the closed position by a rotational movement and thus serves to generate a flow communication between the inside of the casing and the outer side of the casing for the purpose of pressure balance.

In this case, the deflection of the movable part 3 causes the building up of a restoring force of, in this case, four springs that is directed against the direction of deflection. On falling below a presettable closing pressure, the restoring force of the springs 13 applied to the movable part 3 causes that the movable part 3 is moved back from the opened position to the closed position.

The springs 13 bear at one end on the static part 2 of the safety fitting 1 and, at the other end, on the movable part 3 of the safety fitting 1. The springs 13 are designed here as torsion springs. Each spring 13 has respectively at the one end a free end 14, 15. This being, the one free end 14 cooperates with a spring seat 16 of the static part 2 that is arranged on the frame 4. Conversely, the other free end 15 cooperates with a spring seat 17 of the movable part 3 that is arranged on the flap 6.

Furthermore, the springs 13 comprise each a helical portion 18 that is respectively coaxially arranged on the shaft 9. This being, the springs 13 are arranged on the shaft 9 spaced from one another in the axial direction.

FIG. 2 shows the safety fitting 1 according to FIG. 1 in opened position.

It can be seen that the movable part 3 is rotationally deflected in the manner of a flap with respect to the static part 2 and is pushed out of the gasket seat 7 of the static part 2.

Thereto, the inner pressure in the casing has reached the preset response pressure of the safety fitting.

The restoring force applied to the movable part 3 by the springs 13 has been overcome after the response pressure has been reached.

In the opened condition, there is a flow communication between the inside of the casing and the outer side of the casing via the passage hole 8.

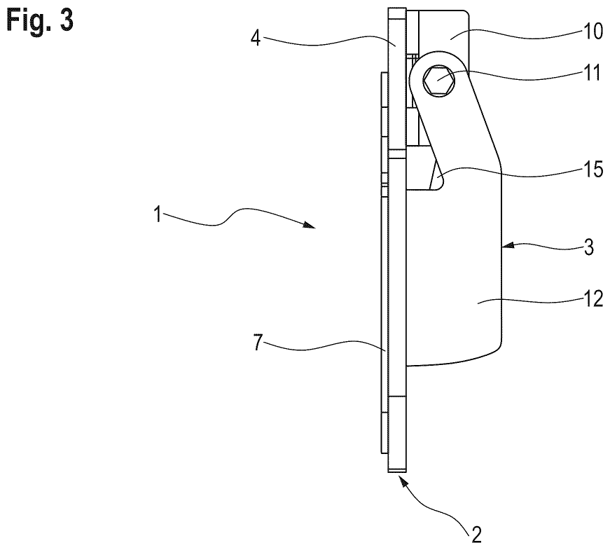

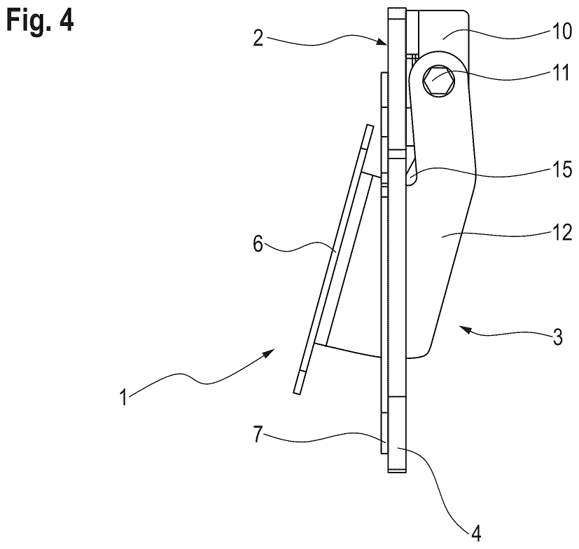

FIGS. 3 and 4 show a lateral view of the embodiment according to FIGS. 1 and 2, FIG. 3 in closed form and FIG. 4 in opened form.

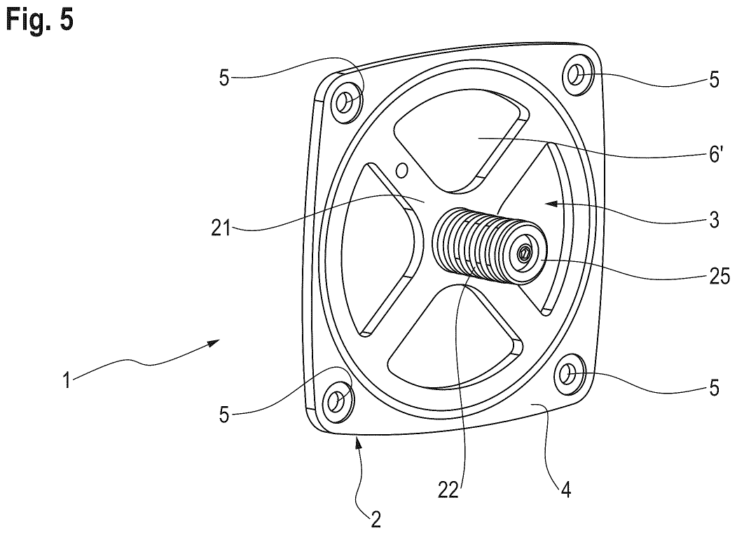

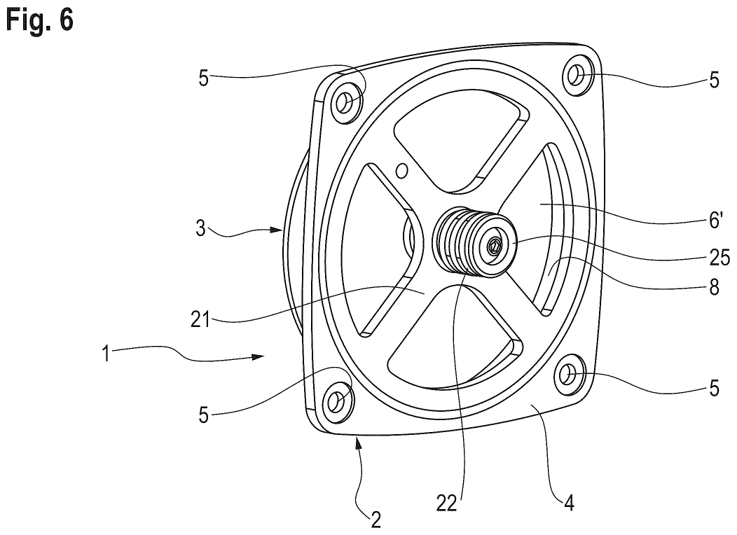

FIGS. 5 and 6 show a second safety fitting 1 according to the disclosure. The safety fitting 1 is designed as a plate check valve. The design as a plate check valve has, among others, the advantage of high mechanical stability in case of a multitude of opening and closing operations. Furthermore, such a valve enables extended possibilities for the control and/or regulation of the volume flow.

It comprises a static part 2 and a movable part 3. Insofar, the safety fitting 1 is designed in at least two parts. This being, the static part 2 of the safety fitting 1 is arranged on the casing, that is not represented here, immovably relative thereto. For the immovable arrangement on the casing, the static part 2 that comprises here a circumferential frame 4 has holes for receiving fixing means such as screws for example. The holes 5 are provided by the frame 4.

By contrast, the movable part 3 is arranged movable relative to the housing and to the static part 2 on the static part 2 of the safety fitting 1. The movable part 3 provides a closing element as a circular disc 6′ that constitutes the “plate” of the plate check valve. The static part 2 provides a gasket seat 7 with a not shown sealing means. This being, a passage hole 8 (FIG. 6) configured in the casing outer wall is enclosed by the gasket seat 7. The movable part 3 sits below the presettable response pressure in the static part 2 and closes the passage hole 8 fluid-tightly, in particular gas-tightly.

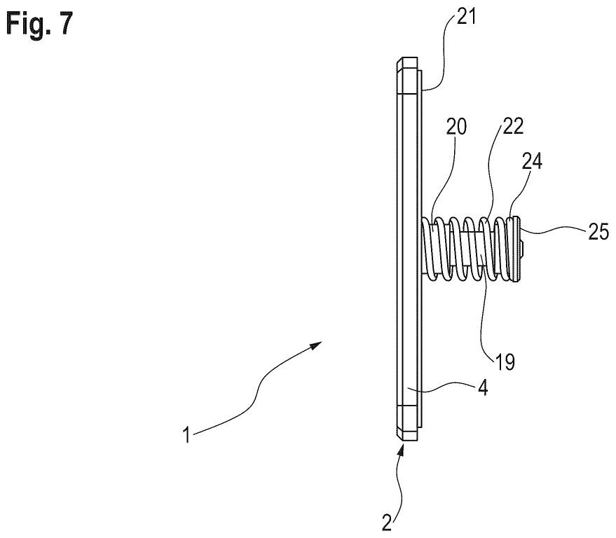

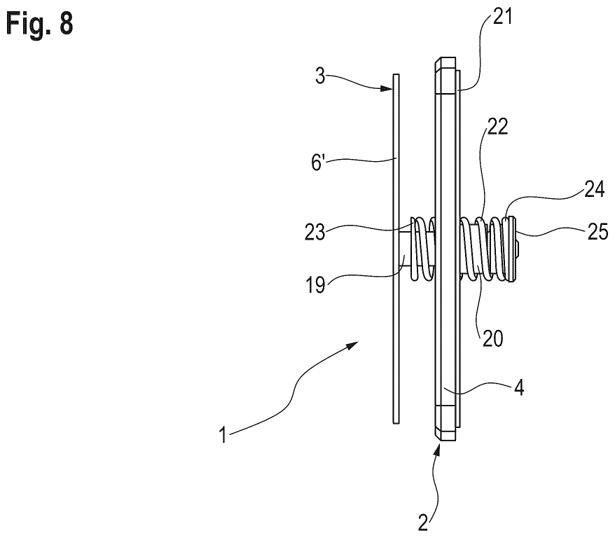

Therefore, the movable part 3 of the plate check valve is designed linearly movable in the axial direction with respect to the static part 2 of the check plate valve or the casing. To this end, the movable part 3 of the plate check valve comprises a guide portion 19 (FIGS. 7 and 8) that is linearly movably guided in a guide seat 20 (FIGS. 7 and 8) of the static part 2 of the check plate valve. This makes possible that, once the response pressure is reached, the movable part 3 of the safety fitting 1 can be pushed by a translational movement out of the closed position into the opened position and thus serve to generate a flow communication between the inside of the casing and the outer side of the casing for the purpose of pressure balance.

The guide seat 20 is arranged at a cross-shaped reinforcing portion 21 of the static part 2. The reinforcing portion is made of two webs intersecting in a central node. The ends of the webs are here connected with the frame 4. A central guide hole for the guide portion 19, enclosed by the guide seat 20, is configured in the node of the cross-shaped portion. The reinforcing portion 21, the guide seat 20, the guide hole, the passage hole 8 and the disk 6′ are arranged coaxially to one another relative to the guide portion 19.

The safety fitting 1 as a plate check valve is here designed as a proportional valve. The opening behavior of the check plate valve is thus proportional to the pressure between reaching the response pressure and the complete opening. The opening pressure is thus above the response pressure. Due to the design as a proportional valve, the plate check valve is advantageously more versatile since it enables a control of the volume flow.

Here, the deflection of the movable part 3 causes the building up of a restoring force of, in this case, a spring 22 that is directed against the translational movement direction. On falling below a presettable closing pressure, the restoring force of the spring 22 applied on the movable part 3 causes that the movable part 3 is moved back from the opened position to the closed position.

The spring 22 bears at one end on the static part 2 of the safety fitting 1 and, at the other end, on the movable part 3 of the safety fitting 1. The spring 22 is here designed as a helical compression spring. The spring 22 has at the one end a free end 23, 24. This being, the one free end 23 cooperates with a not shown spring seat of the static part 2. Conversely, the other free end 24 cooperates with a spring seat 25 of the movable part 3 that is arranged at the end of the guide portion 19 opposed to the disc 6.

The spring 22 is helical and arranged coaxially on the guide portion 19 and the guide seat 20.

FIGS. 7 and 8 show lateral views of the embodiment according to FIGS. 5 and 6, FIG. 7 in closed form and FIG. 8 in opened form.

Regardless of whether the safety fitting 1 is designed as a non-return flap (FIGS. 1 to 4) or as a non-return valve (FIGS. 5 to 8), the safety fitting 1 has a response pressure of 50 hPa to 100 hPa, preferably of 65 hPa to 85 hPa, in particular of 75 hPa.

The response pressure is subject to a tolerance of ±3%. The closing pressure is 10% to 20% below the response pressure.

The opening pressure is here 5% to 10% above the response pressure.

Of course, the respective embodiment of FIGS. 1 to 8 as a full stroke flap or full stroke valve in which the response pressure corresponds to the opening pressure is also covered by the disclosure.

1. A battery container for rail vehicles, in particular railways and tramways, comprising a casing that provides an inner space for housing lithium-ion batteries, wherein casing comprises a safety fitting that is designed to divert at least one fluid from the inner space of the casing in case of exceeding a presettable actuation pressure and to fluid-tightly seal the casing on falling below a presettable closing pressure.

2. The battery container according to claim 1, wherein the safety fitting is designed as a check valve.

3. The battery container according to claim 2, wherein the check valve is designed as a non-return flap.

4. The battery container according to claim 2, wherein the check valve is designed as a non-return valve, in particular as a plate check valve.

5. The battery container according to claim 4, wherein the non-return valve is designed as a proportional valve or as a full stroke check valve.

6. The battery container according to claim 1, wherein the safety fitting is designed to automatically open a flow communication between the inner space of the casing and the outer side of the casing, once the presettable response pressure in the inner space of the casing is reached, and to automatically shut-off the flow communication on falling below the presettable closing pressure in the inner space of the casing.

7. The battery container according to claim 2, wherein the safety fitting is spring-loaded against the pressure acting thereon in the inner space of the casing.

8. The battery container according to claim 1, wherein the safety fitting is made of two parts, wherein a static part of the safety fitting is arranged on the casing immovably thereto and wherein a movable part is arranged movable relative to the housing on the static part of the safety fitting, wherein the movable part of the safety fitting serves to generate the flow communication by a rotational or translational movement once the response pressure is reached.

9. The battery container according to claim 8, wherein at least one spring that bears at one end on inner side of the casing or on the static part of the safety fitting and, at the other end, on the movable part of the safety fitting.

10. The battery container according to claim 9, wherein the spring is designed as a torsion spring when the safety fitting is designed as a non-return flap.

11. The battery container according to claim 9, wherein the spring is designed as a helical tension spring or as a helical compression spring when the safety fitting is designed as a non-return valve.

12. The battery container according to claim 1, wherein a collecting pipe and/or a collecting tank that is fluidically connected with the inner space of the casing, when exceeding the presettable response pressure.

13. The battery container according to claim 1, wherein the safety fitting has a response pressure of 50 hPa to 100 hPa.

14. A system with a battery container according to claim 1, wherein at least one lithium-ion-battery is arranged in the inner space of the battery container.

15. A vehicle with a system according to claim 14.
